(19) United States
(12) Patent Application Publication
(10) Pub. No.: US 2005/0061774 A1
(43) Pub. Date: Mar. 24, 2005

(54) Apparatus and method for non-contact shaping and smoothing of damage-free glass substrates

(75) Inventors: Jude Kelley, Belmont, CA (US); Jeffrey W. Carr, Livermore, CA (US); Peter S. Fiske, Oakland, CA (US); Andrew Chang, Oakland, CA (US)

Correspondence Address: FLIESLER MEYER, LLP, FOUR EMBARCADERO CENTER, SUITE 400, SAN FRANCISCO, CA, 94111, US

(73) Assignee: RAPT Industries, Inc., Livermore, CA (US)

(21) Appl. No.: 10/913,808

(22) Filed: Aug. 6, 2004

Related U.S. Application Data
(60) Provisional application No. 60/495,160, filed on Aug. 14, 2003.

(51) Int. Cl. C03C 15/02; C23F 1/12

(52) U.S. Cl. 216/67; 216/59; 216/74; 65/29.12; 65/102; 65/111

(57) ABSTRACT

High-quality glass parts, such as high-end optics, can be generated using a completely damage free process. An intial damage-free forming step, such as sluping, can be used to roughly shape a glass workpiece without imparting any subsurface damage. A reactive atom processing (RAP) process can then be used to rapidly remove any anomalies or imperfections from the surface of the optic without imparting any damage unto the optic. This description is not intended to be a complete description of, or limit the scope of, the invention. Other features, aspects, and objects of the invention can be obtained from a review of the specification, the figures, and the claims.

### CLAIM OF PRIORITY

This application claims priority to U.S. provisional patent application No. 60/495,160, entitled “Apparatus and Method for Non-Contact Shaping and Smoothing of Damage-Free Glass Substrates,” by Jude Kelley, et al., filed Aug. 14, 2003 (Attorney Docket No. CARR-01007US0).

### CROSS-REFERENCED CASES

The following applications are cross-referenced and incorporated herein by reference:

U.S. patent application Ser. No. 10/008,236 entitled “Apparatus and Method for Reactive Atom Processing for Material Deposition,” by Jeffrey W. Carr, filed Nov. 7, 2001 (Attorney Docket No.: CARR-01000US3).

U.S. patent application Ser. No. 10/383,478 entitled “Apparatus and Method Using a Microwave Source for Reactive Atom Plasma,” by Jeffrey W. Carr, filed Mar. 7, 2003 (Attorney Docket No.: CARR-01001US0).

U.S. patent application Ser. No. 10/384,506 entitled “Apparatus and Method for Non-Contact Cleaning of a Surface,” by Jeffrey W. Carr, filed Mar. 7, 2003 (Attorney Docket No.: CARR-01003US0).

### FIELD OF THE INVENTION

The field of the invention relates to the damage-free modification of surfaces using a reactive atom plasma process.

### BACKGROUND

Modern materials present a number of formidable challenges to the fabricators of a wide range of optical, semiconductor, and electronic components, many of which require precision shaping, smoothing, and polishing. Optical components, such as uniquely or precisely-shaped optics, are commonly formed by a process such as furnace slumping. An array of glass materials can be shaped with such a process, including materials such as borosilicate, fused silica, soda lime, and ULE glass. At the start of the slumping process, a glass blank is molded or formed to a part with a specified shape and thickness, then placed over a precisely shaped mold. Both the glass part and the mold are inserted into a furnace, where the temperature is raised until the glass begins to soften. The glass becomes an extremely viscous liquid as it softens, and as such will undergo slow flow upon application of a force such as gravity. The flowing glass then slumps, or slowly flows downward and sinks, into the shape of the underlying mold. Such a process has the added benefit of producing glass parts with very little surface or subsurface damage, as the softening portion of the process reduces both types of damage. To contrast, imparting gross shape via mechanical grinding causes significantly more damage.

Injection molding is another common process for forming glass parts without introducing significant damage. In such a molding process, glass is heated to the melting point and injected into castings, where the glass is allowed to cool. Damage-free glass can also be produced using a float method, where liquid glass is floated on a surface of molten tin. The float process only produces flat sheets of glass. Yet another means of producing glass parts without significant damage is a spinning process, where molten glass is spun into a desired shape and allowed to cool.

All of the above-mentioned processes share one key feature, in that each process imparts shape into a glass part without introducing any significant damage to the surface and subsurface layers. The quality of the glass parts produced by such processes is dictated by defects in the bulk material, which are side effects of the initial manufacturing processes used to create the glass.

Unfortunately, the previously mentioned slumping, casting, and spinning processes have some limitations that are evident on the surface(s) of the resulting part(s). For example, a certain amount of creasing and rippling may occur during the slumping process, due to buckling of the glass substrate or glass blank. These types of surface form defects are caused by the change in geometry of the parts during the shaping process. Imperfections or particulate contamination on the surfaces of molds may cause irregularities to appear on the surface of the emerging glass. For glass to be of use in a high precision field such as optics, these imperfections must be removed.

Conventional production of finished parts from slumped, cast, or spun glass substrates involves a substantial amount of mechanical grinding and polishing to generate the correct shape. Grinding is typical and is used when the amount of material to be removed to obtain the desired shape is too great to be accomplished by polishing alone. While grinding has high material removal rates, it has the unfortunate side effect of inducing considerable surface and subsurface damage into the part. After grinding is complete, a polishing step must be used to achieve the desired surface smoothness. This polishing step may leave behind a smooth top surface, but it does so via a process that provides considerable force normal to the surface. This force in turn causes the subsurface damage (cracks beneath the surface) to be further propagated into the material. This is undesirable, as subsurface damage can have adverse affects on the overall durability of glass parts, as well as the optical performance of glass used in transmissive applications. While excessive amounts of polishing time can ultimately reduce the amount of subsurface damage in a part, the process is not cost effective and may require removal of more material than desired, affecting the intended final form. Conventional polishing also leaves behind residue from the slurry in the redeposited polish or varnish layer, contaminating what may have been an initially pure substrate.

In modern optical systems, there is an increasing demand for durable precision optics capable of handing high laser fluencies. Subsurface damage and contamination cause destructive failure of optical components in the presence of high fluencies of photons. Small subsurface cracks and asperities in the glass may cause an incident laser beam to produce damaging ‘hot spots’ within the optic or in other parts of the optical system. Contamination of glass with traces from the polishing slurry may cause unwanted differences in the refractive index of the material, compromising the performance characteristics of the optic.

The advantage of the slumping, casting, and spinning processes is the means by which gross shape can be imparted into a work piece without causing damage or contamination. While gross shape is readily applied by these techniques, the resulting parts still require shape corrections if they are to be used for precision applications. Thus there is a pressing need for a follow up step that is able to rapidly perform shape corrections while the work piece remains undamaged and free of contamination.

### BRIEF DESCRIPTION OF THE FIGURES

FIG. 1 shows a diagram of a RAP torch system that can be used in accordance with one embodiment of the present invention.

FIG. 2 shows a RAP torch, similar to that of FIG. 1, in proximity with a slumped optic having residual ridges on the concave surface of the optic.

FIGS. 3(a) and 3(b) are diagrams of a flame torch that can be used in accordance with another embodiment of the present invention.

FIG. 4 is a diagram of an MIP torch system that can be used in accordance with another embodiment of the present invention.

FIG. 5 is a flowchart showing a process that can be used with the system of FIG. 1.

### DETAILED DESCRIPTION

Systems and methods in accordance with embodiments of the present invention can utilize a rapid, non-contact, deterministic material removal process to shape and smooth materials that have been prepared to near-net shape by a damage free formation step such as slumping, injection molding, casting, spinning, or floating. Such an approach can produce finished, damage free parts more rapidly than existing methods that rely upon damage-inducing mechanical grinding for shape corrections.

Systems and methods in accordance with embodiments of the present invention can improve the figure corrections necessary for these damage-free glass parts by eliminating the physical grinding processes and instead correcting the parts using a reactive atom plasma (RAP) process. RAP processes that can be used in accordance with embodiments of the present invention include those described in pending U.S. patent application Ser. Nos. 10/008,236, 10/383,478, and 10/384,506, which are incorporated herein by reference above. A RAP process can remove any surface anomalies, such as blemishes and ripples, from a damage free glass workpiece without imparting any damage to the workpiece. The result can be a high precision optic processed completely by damage free manufacturing. Such an optic can be much more durable than optics made using damage-inducing processes, such that the optic can be made thinner and lighter, and can require less material to make.

Using a RAP process on a damage-free glass part can be more efficient than using RAP on a ground glass part, because less material will need to be removed from the part. When using a mechanical grinding process to form the part, subsurface damage is imparted into the workpiece that must be removed. The layers of damage will have increased roughness at the beginning of the removal process, and only become smooth when the process passes through all the damage. In the case of a damage-free optic, such as a blown piece of glass, it is possible to take off as much or as little of the surface material as desired, as there is no layer of damage to be removed.

For example, a ripple in a piece of shaped glass can be on the order of two millimeters or so in thickness, but there may be parts of the same piece of glass that require the removal of only on the order of tens of nanometers. If a piece of glass is formed by mechanical grinding processes, removing a micron of material can produce an extremely rough surface, as the removal process has cut into the sub-surface damage layer. In order to get rid of this roughness, it is necessary to remove material until the process goes below the damage layers. Using a RAP procedure in such a situation can be orders of magnitude faster than using existing polishing or grinding systems, but still can be slower than desired. Using a damage-free shaping technique in combination with a RAP process allows a manufacturer to start with a damage-free, near-desired shape, and allows the manufacturer to quickly process only those portions of the surface that need correction. Since less material needs to be removed, the final shape can be reached much more quickly can result in a very high quality surface.

One such RAP process can utilize a deterministic, atmospheric pressure plasma tool to perform shape corrections on slumped, cast, or spun glass parts in order to produce shaped glass workpieces or glass parts that are virtually free of damage free, and that are chemically pure and mechanically sound. The use of such a tool allows the traditional step of mechanical grinding to be replaced with a reactive atomic plasma (RAP) process. Since a RAP etching process is chemical, and therefore virtually non-contact in nature, the etching process does not induce damage into the glass while the glass is being shaped and/or smoothed. RAP technology enables sufficient material removal rates to allow for the quick removal of shape defects from glass workpieces, such as workpieces that have been slumped, cast, spun, or floated. The chemistry of a RAP process provides the ability to etch a variety of different types of glass, including glass containing up to 30% non-SiO₂ components. Exemplary types of glass that can be etched with such a process can include composite glasses such as borosilicate, soda lime, and ULE.

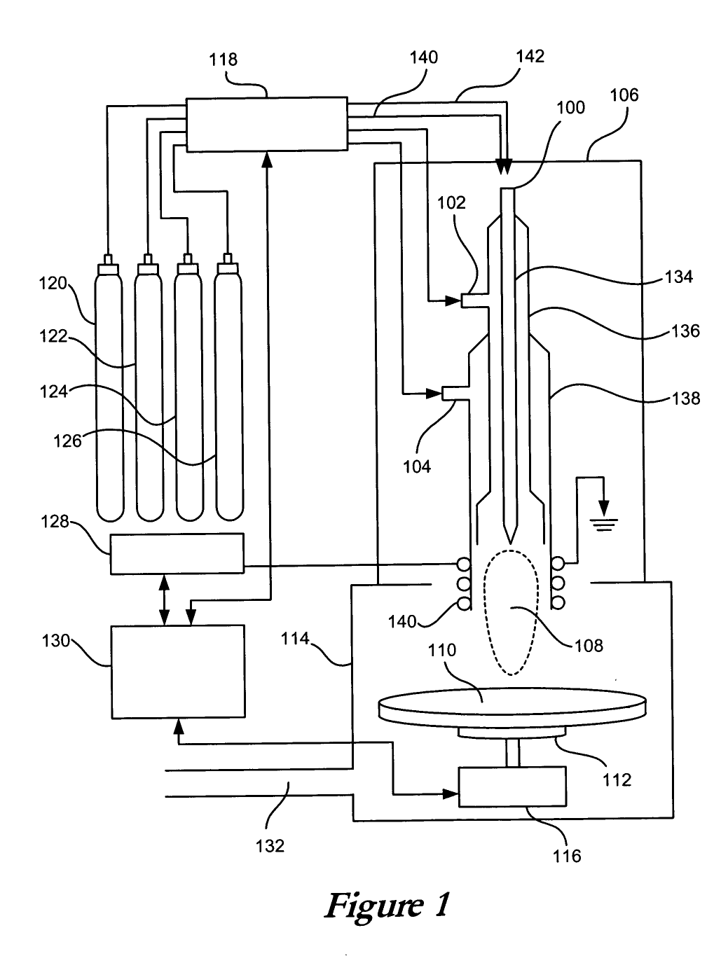

One such RAP system is shown, for example, in the diagram of FIG. 1. The exemplary torch, shown in a plasma box 106, consists of an inner tube 134, an outer tube 138, and an intermediate tube 136. The inner tube 134 has a gas inlet 100 for receiving a stream of reactive precursor gas 142 from a mass flow controller 118. The torch can utilize different precursor gases during different processing steps. For instance, the torch might utilize a precursor adapted to clean a particular contaminant off a surface in a first step, while utilizing a precursor for redistributing material on the surface of the workpiece during a second step.

The intermediate tube 136 has a gas inlet 102 that can be used to, for example, receive an auxiliary gas from the flow controller 118. The outer tube 138 has a gas inlet 104 that can be used to receive plasma gas from the mass flow controller 118. The mass flow controller 118 can receive the necessary gases from a number of gas supplies 120, 122, 124, 126, and can control the amount and rate of gases passed to the respective tube of the torch. The torch assembly can generate and sustain plasma discharge 108, which can be used to modify the surface of a workpiece 110 located on a chuck 112, which can be located in a workpiece box 114. A workpiece box 114 can have an exhaust 132 for carrying away any process gases or products resulting from, for example, the interaction of the plasma discharge 108 and the workpiece 110.

The chuck 112 in this embodiment is in communication with a translation stage 116, which is adapted to translate and/or rotate a workpiece 110 on the chuck 112 with respect to the plasma discharge 108. The translation stage 116 is in communication with a computer control system 130, such as may be programmed to provide the necessary information or control to the translation stage 116 to allow the workpiece 110 to be moved along a proper path to achieve a desired cleaning, shaping, and/or polishing of the workpiece. The computer control system 130 is in communication with an RF power supply 128, which supplies power to the torch. The computer control system 130 also provides the necessary information to the mass flow controller 118. An induction coil 140 surrounds the outer tube 138 of the torch near the plasma discharge 108. Current from the RF power supply 128 flows through the coil 140 around the end of the torch. This energy is coupled into the plasma.

After a damage-free glass part has been obtained, or has been created using a process such as slumping, casting, or spinning, there may be particulate contamination on the surface of the part that can adversely affect the precision of a RAP process. Since a RAP process is a chemical process, foreign matter on the surface of a glass workpiece can act as a mask in the case of inert particles, or as a flux in the case of chemically active particles. Any appropriate method known or used in the art can clean away the contamination and prepare a chemically consistent surface, such as passing a gentle pad polish across the surface of the workpiece. The need for such a step can be highly dependent upon the cleanliness of the environment in which the workpiece was prepared.

Once a glass part is sufficiently free of contamination, any appropriate process can measure the shape of the surface. Such processes can include the use of stylus profilometry, interferometry, or Slack-Hartman type sensor arrays. Once the surface has been examined, and information such as the coordinates of the surface topography has been captured, the information can be examined to calculate an appropriate tool path algorithm. The examination of the information can include, for example, feeding the information into a computer program or computer control system, along with the desired shape, such that the differences between the measured shape and the desired shape can be used to generate the tool path algorithm. For example, a small optic part can be placed on a computer-controlled stage to enable translation of the part relative to a plasma torch, which can be stationary or capable of translation and/or rotation. For larger optics, such as those with a diameter greater than about one meter, the optic part can remain stationary while a specially outfitted torch translates relative to the workpiece, such as by using a motion stage or robotic arm. After treatment with a reactive plasma tool, an optic can again be measured and the entire process iterated until the desired parameters for shape convergence have been met.

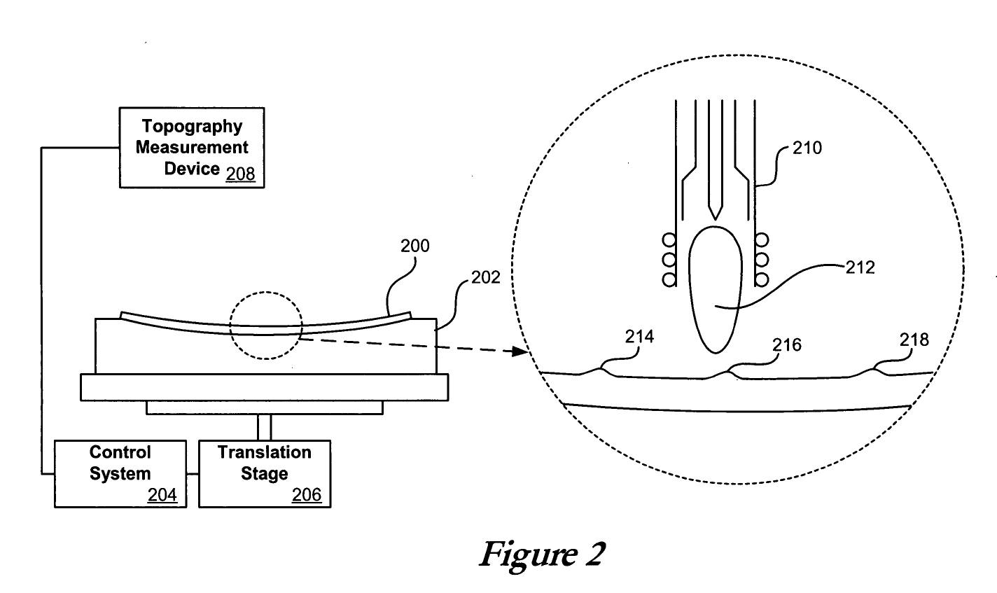

FIG. 2 shows an example of a glass optic 200, produced by a slumping process, which can be processed using such a procedure. A topography measurement device 204, such as an interferometer or stylus device, can determine the topography of the concave surface of the optic 200 on the slumping mold 202, and can feed that information to a computer control system 206. The computer control system can use the topography information to determine an appropriate tool path algorithm to be used in removing undulations from the surface. The algorithm can be determined using information such as the location of the undulations, the type of material, the size of the undulations, and the length of time necessary at each spot to remove the undulations. The tool path algorithm can be used to move the optic relative to a RAP torch 210. The torch itself may be translated and/or rotated, or the optic can be moved with respect to the torch, such as through use of a translation stage 208. The plasma 212 of the RAP torch 210 can then remove the undulations 214, 216, 218 on the surface by following the tool path algorithm and spending an appropriate amount of time at each undulation. The torch may process each undulation individually, or may move in a pattern such as a raster pattern over the surface in order to process the undulations. The distance between the torch and the surface of the optic can also be varied according to the topography measurement, in order to provide a more even, controllable removal, as well as to prevent any contact between the torch and the optic.

The shape of the plasma footprint does not change significantly over a fairly large range of tilt with respect to the central axis of the torch. For example, the central axis of the torch, running parallel to the length of the central tube, can be positioned orthogonally with respect to a surface being modified. The central axis can be tilted a certain amount, such as up to about eight degrees with respect to the surface, without changing the effective footprint of the plasma. A high degree of tilt such as 55°, however, can cause a substantial deformation of the effective footprint. Since the plasma is stable, however, this deformation can be modeled and accounted for in any tool-control algorithm.

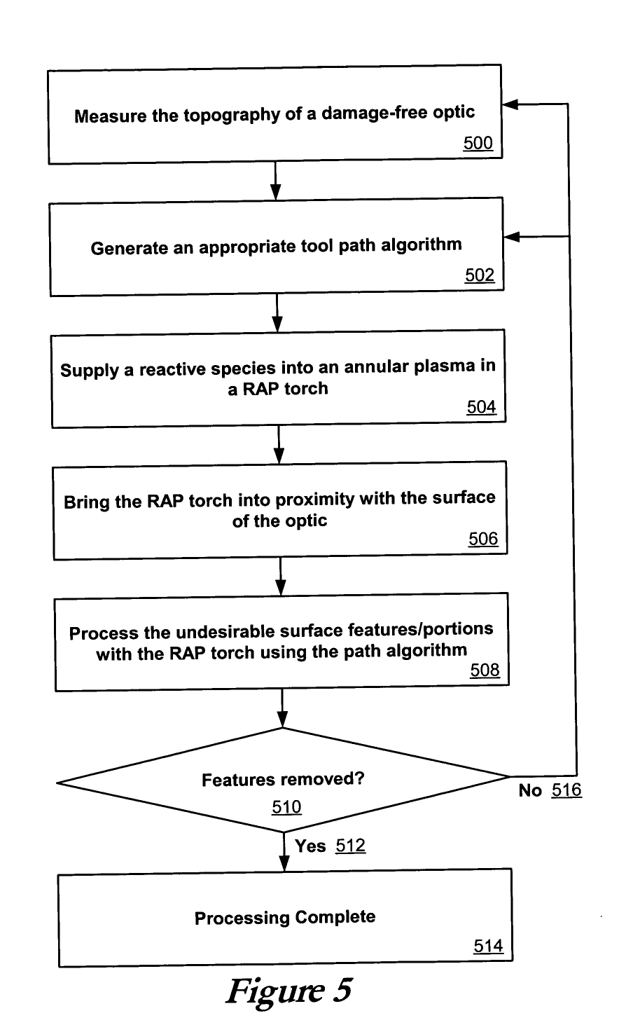

FIG. 5 shows a similar process that can be used in accordance with embodiments of the present invention. In such a process, the topography of a damage-free optic is measured 500 and an appropriate tool path algorithm is generated 502. A reactive species is supplied to an annular plasma in a RAP torch 504, where the reactive species is selected in order to react with the material of the optic. The RAP torch is brought into proximity with the optic 506, and the features to be removed from the surface are processed using the RAP torch 508. Once the torch processes all the features, the optic is examined to determine if the undesirable features have been sufficiently removed 510 and/or the optic has been appropriately shaped. If so 512, the processing of the optic is complete 514. If not 516, the process can repeat starting with step 500 or step 502, depending upon whether another surface determination is needed other than that used at step 510.

One advantage to using a RAP process to shape a damage-free glass workpiece is that there is no damage evolution to deal with when removing material, as the glass is formed in the liquid state with no grinding or polishing. In the case of mechanically polished glass, there is a damage layer beneath the surface that must be removed before the relatively damage free bulk material can be reached. It is not necessary to remove material for the sake of damage mitigation when starting with damage free material, which can make shaping a glass part both easier and faster.

The polishing properties of a RAP process can leave substrate surfaces in a sufficiently smooth state for many different applications. For certain applications, such as where ultra-smooth surfaces are required, a conventional polishing can be implemented after a RAP treatment if necessary. A mechanical polishing step at this stage can leave behind an ultra-smooth surface with very little damage, since the omitted grinding step is traditionally the primary cause of surface and subsurface damage. Mechanical polishing, on the other hand, tends to propagate surface and subsurface damage, such that if the surface is damage-free there can be no harm in polishing the surface.

Glass parts and optics created using a RAP approach in accordance with embodiments of the present invention have been shown to possess superior laser damage thresholds when compared to optics produced through mechanical grinding, in addition to increased overall durability. An increase in durability is desirable for many precision optics, such as those used in hostile environments.

Slumping

As mentioned above, one process that can be used to shape a damage-free glass workpiece is slumping. Slumping can be used to form glass into shapes that can vary from precision optics, having a relatively slight curvature, to objects having many degrees of curvature. Slumping can be used to form objects such as bowls, windshields, and lampshades. Slumping, as with many of these processes, is typically used in optical manufacturing when the goal is an optic that is a mirror or a lens having a particular shape. Such a goal can be difficult to obtain through grinding and similar mechanical processes, as these processes can take a lot of time, can be quite difficult, and usually require the removal of a significant amount of material. To avoid these problems, optics manufacturers often create a mold or other shaped tool that has the mirror image of the optic to be created. Glass molds are made out of a number of appropriate materials, such as silicon carbide, and can be made by any of a number of processes including a RAP process. A piece of glass, such as a flat piece of glass that has been cut from a glass bulk, can be positioned above the mold and placed into a furnace. The glass will slowly soften while warming, and the force of the gravity will pull the glass down into the mold. Once the glass has fallen sufficiently into the mold, the glass and mold can be removed from the furnace such that the glass can cool. The glass can be placed into a heater or furnace such that the temperature of the glass can be controlled to decrease gently. Or, the glass part can remain in the furnace and the part can cool along with the furnace. For certain applications the furnace can remain at the appropriate temperature and a conveyor-belt type apparatus can be used to move the parts in and out of the furnace. Such a conveyor process can stress in the resultant optics, but for certain applications this amount of stress might not matter. After cooling, the resulting glass part will have approximately the desired shape imparted by the mold.

Slumping processes can also be more flexible than physical grinding and shaping processes. For example, slumped parts can have glass fins on the molded side that can allow a lightweight optic to be extremely rigid. Also, slumping a part by heating glass near its softening point actually forms a shape into the glass object without imparting the damage or cracks that result from a physical shaping process that involves materials such as a grinding wheel or harsh abrasives. Slumping is not a perfect process, however, as there are typically some irregularities in the glass part after slumping. When a glass plate is formed into a bowl, for example, ridges can appear on the concave side of the bowl. Ridges can form on any concave portion of the surface. These ridges are typically not acceptable, such as in applications for fabricating precision mirrors for telescopes. A problem then arises as to how to remove the ridges. The only existing way to remove these ridges is by grinding or extensive polishing, which can take significant amounts of time and be very uneconomical.

A slumped part can be processed while hot, or can be allowed to cool before processing. Staring RAP processing on a hot part can save a lot of time. It might not be possible to make a fine correction while the part is hot, as the part may continue to flow, but a coarse correction can be made. For example, at least portions of large ridges can be removed while cooling. Many existing metrology devices will not allow measurements on a hot part, so such an application may find use where a number of parts having a fairly-well known shape are produced under substantially similar conditions, such that the non-uniformity between parts is minimal. For example, certain slumping applications have shown less than 5% diversion. If the degree of variation is known, it can be used in a tool path algorithm to predict at least an outer bound of the shape of the part. A RAP process can then be used to shape any portion of the part exceeding that outer bound. Also, the variations may be substantially similar in location such that no part-by-part measurement is necessary. Processing a hot part can also greatly increase the speed of the process. The processing can be done in the oven, but for many applications the part can be moved into another container or oven for processing. If the glass part is sufficiently large, processing while hot can greatly reduce the time to correct the shape, such as by a one half reduction.

Manufacturers primarily use slumping to produce optics that are relatively large and expensive to make, because it is expensive to correct the shape of the optics. Smaller objects can be made more easily by following standard principles. By using a RAP process to correct damage-free glass shapes, the use of slumping can be expanded to a whole new range of applications because RAP is a quick, non-contact, damage-free process. For example, an application might take advantage of an off-access parabolic mandrel. A sheet of eight-inch thick float glass can be placed on the mandrel and heated until the glass completely sags over the mandrel and becomes very thin. The glass will not follow the shape of the mandrel perfectly, and will need to be corrected. Since a RAP process is virtually pressure free, this very, very thin piece of glass can be corrected to make a very good optic. Such a result was not previously possible.

Other Potential Applications and Advantages

The ability to quickly and easily manufacture shaped objects can have a drastic effect on any applications that take advantage of lens trains. Lens trains take advantage of multiple optical elements since most optics are either planes or spheres. Any other shapes have up until now been difficult and/or expensive to make. The limited availability of shapes requires the use of additional elements to appropriately bend or focus the light, as well as additional elements with different indexes of refraction to compensate for the shapes and surfaces. If it is desired to have a lens focus an image in a plane with the appropriate colors, it is necessary to have lens elements with different indexes of refraction and different shapes as known to one of ordinary skill in the art. As the number of possible shapes increases, the number of elements necessary to properly focus the image can decrease. For example, a zoom lens for a camera might have 15 elements. If it is possible to build an optic of any shape and size, the number of elements can be reduced to 3 to 5.

One class of lenses, known as aspheres, is popular for use as elements in lens trains because aspheres can reduce the number of necessary elements. Aspheres can also be lightweight and easy to produce. For example, simple aspheres having a reasonably high quality, such as could be placed in a typical camera lens, can be injection molded. For more precise applications, however, aspheres can be formed using a damage-free/RAP process such as those described above in accordance with embodiments of the present invention.

Another area that can significantly benefit from embodiments of the present invention involves applications requiring the use of high intensity ultraviolet rays, also known as Extreme UV applications. Technology areas such as semiconductor manufacturing are exploring extreme UV applications capable of generating smaller trace sizes. Such an application requires a lens that can withstand the amount of energy required. Passing extreme UV through a lens does a lot of damage to a traditional optic, and existing applications require the periodic swapping of optic elements. Damage-free optics made in accordance with embodiments of the present invention, however, are much more durable and have incredibly good resilience in the high fluency lasers. While each optic can be quite expensive, not just due to the necessary precision but due to the need to use materials such as quartz, the durability and improved performance will generate significant cost reductions in such a process.

Other RAP Systems

In addition to an ICP plasma torch, other RAP torches can be utilized in accordance with embodiments of the present invention, such as a simple flame or flame torch. In one example, a hydrogen-oxygen (H₂/O₂) flame can be adjusted to burn with an excess of oxygen. A device using such a simple flame can be cheaper, easier to develop and maintain, and significantly more flexible than an ICP device. A flame is struck on such a flame torch, and a reactive precursor is supplied to the flame. The surface of the workpiece can then be modified by allowing radicals or fragments of the reactive precursor to combine with the heated portions of the workpiece surface to produce a gas and leave the surface.

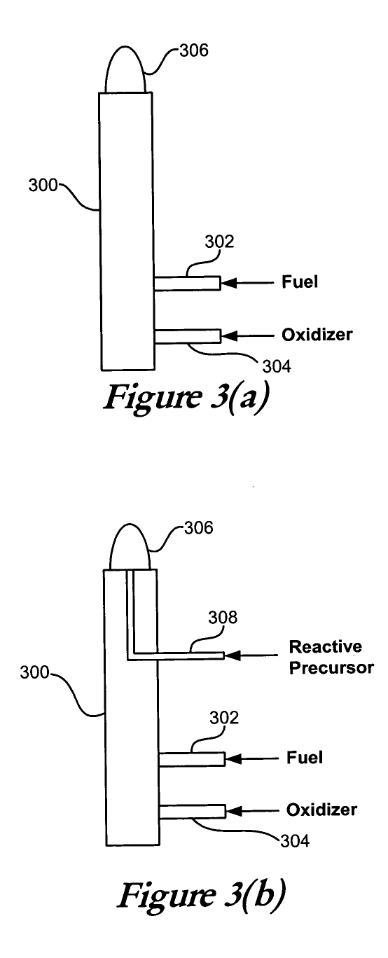

Such a flame torch can be designed in several ways. In the relatively simple design of FIG. 3(a), a reactive precursor gas can be mixed with either the fuel or the oxidizer gas before being injected into the torch 300 through the fuel input 302 or the oxidizer input 304. Using this approach, a standard torch could be used to inject the precursor into the flame 306. Depending on the reactive precursor, the torch head might have to be made with specific materials. For example, mixing chlorine or chlorine-containing molecules into an H₂/O₂ torch can produce reactive chlorine radicals.

The slightly more complex exemplary design of FIG. 3(b) can introduce the reactive precursor gas into the flame 306 using a small tube 308 in the center of the torch 300 orifice. The flame 306 in this case is usually chemically balanced and is neither a reducing nor oxidizing flame. In this design a variety of gases, liquids, or solids can be introduced coaxially into the flame to produce reactive components. The torch in this embodiment can produce, for example, O, Cl, and F radicals from solid, liquid, and gaseous precursors.

In any of the above cases, a stream of hot, reactive species can be produced that can chemically combine with the surface of a part or workpiece. When the reactive atoms combine with the contaminants, a gas is produced that can leave the surface.

While a RAP system can operate over a wide range of pressures, the most useful implementation can involve operation at or near atmospheric pressure, facilitating the treatment of large workpieces that cannot easily be placed in a vacuum chamber. The ability to work without a vacuum chamber can also greatly increase throughput and reduce the cost of the tool that embodies the process.

A flame system can easily be used with a multi-nozzle burner or multi-head torch to quickly cover large areas of the surface. For other applications, a small flame can be produced that affects an area on the surface as small as about 0.2 mm full width-half maximum (FWHM) for a Gaussian- or nearly Gaussian-shaped tool. Another advantage of the flame system is that it does not require an expensive RF power generator or shielding from RF radiation. In fact, it can be a hand-held device, provided that adequate exhaust handing equipment and user safety devices are utilized. Further, a flame torch is not limited to a H₂/0₂ flame torch. Any flame torch that is capable of accepting a source of reactive species, and fragmenting the reactive species into atomic radicals that can react with the surface, can be appropriate.

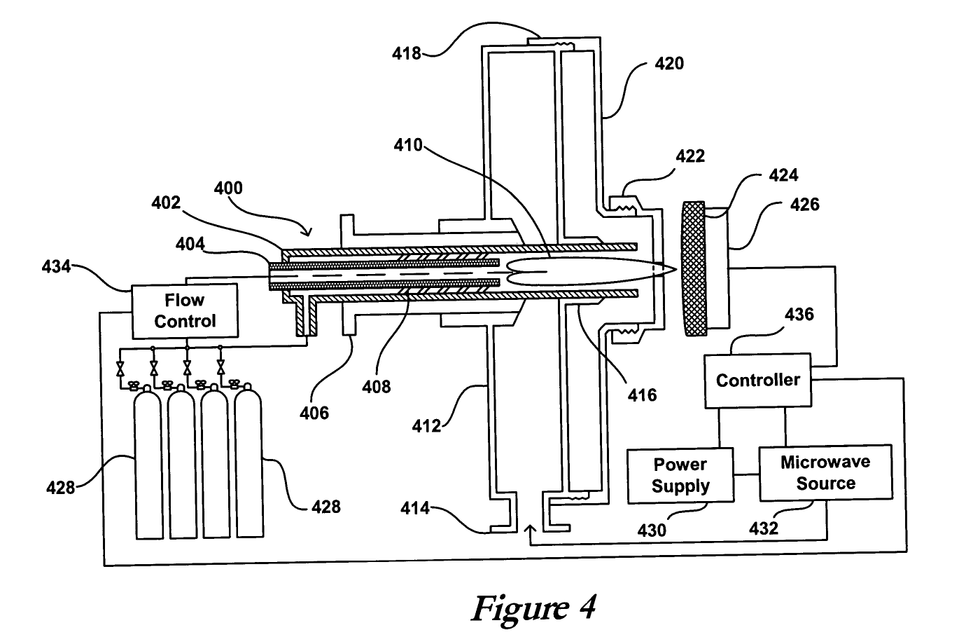

As shown in FIG. 4, another RAP system that can be used in accordance with the present invention utilizes a microwave-induced plasma (MIP) source. An MIP source has proven to have a number of attributes that complement, or even surpass in some applications, the use of an ICP tool or a flame as an atomization source. The plasma can be contained in a quartz torch 400, which is distinguished from a standard ICP by the use of two concentric tubes instead of three. With a large enough bore, a torroidal plasma can be generated and the precursor injected into the center of the torch in a manner analogous to the ICP.

A helical insert 408 can be placed between the outer tube 402 and the inner tube 404 of the torch 400 to control tube concentricity, as well as to increase the tangential velocity of gas. The vortex flow can help stabilize the system, and the high velocity can aid in cooling the quartz tubes 402, 404.

The main portion of the microwave cavity 412 can be any appropriate shape, such as a circular or cylindrical chamber, and can be machined from a highly conductive material, such as copper. The energy from a 2.45 GHz (or other appropriate) power supply 430 can be coupled into the cavity 412 through a connector 414 on one edge of the cavity. The cavity 412 can be tuned in one embodiment by moving a hollow cylindrical plunger 406, or tuning device, into or out of the cavity 412. The quartz torch 400 is contained in the center of the tuning device 406 but does not move while the system is being tuned.

An external gas sheath 420 can be used to shield the plasma 420 from the atmosphere. The sheath 420 confines and can contribute to the longevity of the reactive species in the plasma, and can keep the atmospheric recombination products as low as practically possible. In one embodiment, the end of the sheath 420 is approximately coplanar with the open end, or tip, of the torch 400. The sheath 420 can be extended beyond the tip of the torch 400 by installing an extension tube 322 using a threaded flange at the outlet of the sheath 420. The sheath itself can be threadably attached 418 to the main cavity 412, which can allow a fine adjustment on height to be made by screwing the sheath either toward or away from the cavity 412.

A supply of process gas 428 can provide process gas to both tubes 402,404 of the torch 400. In one embodiment this process gas is primarily composed of argon or helium, but can also include carbon dioxide, oxygen or nitrogen, as well as other gases, if the chemistry of the situation permits. Gas flows in this embodiment can be between about one and about ten liters per minute. Again, the gases introduced to the torch can vary on the application. Reactive precursor gas(es) can be introduced to clean a surface, for example, followed by a different precursor gas(es) to shape or otherwise modify the surface of the workpiece. This allows a workpiece to be cleaned and processed in a single chamber without a need to transfer the workpiece to different devices to accomplish each objective.

Chemistry

A reactive atom plasma process in accordance with embodiments of the present invention is based, at least in part, on the reactive chemistry of atomic radicals and reactive fragments formed by the interaction of a non-reactive precursor chemical with a plasma. In one such process, the atomic radicals formed by the decomposition of a non-reactive precursor interact with material of the surface of the part being modified. The surface material is transformed to a gaseous reaction product and leaves the surface. A variety of materials can be processed using different chemical precursors and different plasma compositions. The products of the surface reaction in this process must be a gas under the conditions of the plasma exposure. If not, a surface reaction residue can build up on the surface which will impede further etching.

In the above examples, the reactive precursor chemical can be introduced as a gas. Such a reactive precursor could also be introduced to the plasma in either liquid or solid form. Liquids can be aspirated into the plasma and fine powders can be nebulized by mixing with a gas before introduction to the plasma. RAP processing can be used at atmospheric pressure. RAP can be used as a sub-aperture tool to precisely clean and shape surfaces.

A standard, commercially-available two- or three-tube torch can be used. The outer tube can handle the bulk of the plasma gas, while the inner tube can be used to inject the reactive precursor. Energy can be coupled into the discharge in an annular region inside the torch. As a result of this coupling zone and the ensuing temperature gradient, a simple way to introduce the reactive gas, or a material to be deposited, is through the center. The reactive gas can also be mixed directly with the plasma gas, although the quartz tube can erode under this configuration and the system loses the benefit of the inert outer gas sheath.

Injecting the reactive precursor into the center of the excitation zone has several important advantages over other techniques. Some atmospheric plasma jet systems, such as ADP, mix the precursor gas in with the plasma gas, creating a uniform plume of reactive species. This exposes the electrodes or plasma tubes to the reactive species, leading to erosion and contamination of the plasma. In some configurations of PACE, the reactive precursor is introduced around the edge of the excitation zone, which also leads to direct exposure of the electrodes and plasma contamination. In contrast, the reactive species in the RAP system are enveloped by a sheath of argon, which not only reduces the plasma torch erosion but also reduces interactions between the reactive species and the atmosphere.

The inner diameter of the outer tube can be used to control the size of the discharge. On a standard torch, this can be on the order of about 18 to about 24 mm. The size can be somewhat frequency-dependent, with larger sizes being required by lower frequencies. In an attempt to shrink such a system, torches of a two tube design can be constructed that have an inner diameter of, for example, about 14 mm. Smaller inner diameters may be used with microwave excitation, or higher frequency, sources.

The foregoing description of preferred embodiments of the present invention has been provided for the purposes of illustration and description. It is not intended to be exhaustive or to limit the invention to the precise forms disclosed. Many modifications and variations will be apparent to one of ordinary skill in the art. The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalence.

1. A method for shaping a damage-free part, comprising:
measuring the topography of a surface of a damage-free part; and
using a reactive atom plasma to remove variations in the topography.

2. A method according to claim 1, further comprising:
forming a damage-free part.

3. A method according to claim 1, further comprising:
generating a tool path algorithm using the measured topography, the tool path algorithm designed to remove the variations.

4. A method according to claim 1, further comprising:
supplying a reactive species into the plasma, the reactive species selected to react with the surface material of the part.

5. A method according to claim 1, further comprising:
using a plasma torch to generate the plasma.

6. A method according to claim 5, wherein:
the plasma torch is selected from the group consisting of ICP torches, MIP torches, and flame torches.

7. A method according to claim 1, further comprising:
re-measuring the topography after using the reactive atom plasma.

8. A method according to claim 1, further comprising:
using the reactive atom plasma to shape the surface of the part.

9. A method according to claim 1, further comprising:
using the reactive atom plasma to smooth the surface of the part.

10. A method according to claim 1, further comprising:
forming a damage-free part to near-net shape before measuring the topography.

11. A method according to claim 10, wherein:
forming a damage-free part involves a formation process selected from the group consisting of slumping, injection molding, melting, casting, spinning, and floating.

12. A method according to claim 1, wherein:
the variations being remove include variations selected from the group consisting of surface anomalies, blemishes, and ripples.

13. A method according to claim 1, wherein:
using a reactive atom plasma to remove variations in the topography does not impart damage unto the optic.

14. A method according to claim 1, wherein:
the part is a high precision optic.

15. A method according to claim 1, wherein:
using a reactive atom plasma to remove variations in the topography involves quickly processing only those portions of the surface that need correction.

16. A method according to claim 1, wherein:
measuring the topography includes a measurement process selected from the group consisting of stylus profilometry, interferometry, and Slack-Hartman type sensor arrays processes.

17. A method according to claim 1, further comprising:
moving at least one of the part and the plasma with respect to each other.

18. A method according to claim 1, wherein:
the plasma is an annular plasma.

19. A method according to claim 1, further comprising:
allowing the part to cool before measuring the topography.

20. A method according to claim 1, further comprising:
using a reactive atom plasma to remove variations in the topography without allowing the part to cool.

21. A method according to claim 1, wherein:
the part is an asphere.

22. A method according to claim 1, wherein:
the part is capable of withstanding high intensity ultraviolet rays.

23. A method according to claim 1, further comprising:
removing contamination from the surface of the part before using a reactive atom plasma to remove variations in the topography.

24. A method according to claim 1, further comprising:
producing a stream of atomic radicals from a reactive species injected into the plasma.

25. A method according to claim 24, further comprising:
striking a plasma capable of fragmenting the reactive species into atomic radicals.

26. A method according to claim 1, further comprising:
supplying a source of fuel to the plasma.

27. A method according to claim 1, wherein:
using a reactive atom plasma to remove variations in the topography occurs at about atmospheric pressure.

28. A method according to claim 1, further comprising:
modifying the surface of the part with the plasma.

29. A method according to claim 1, further comprising:
polishing the surface of the part with the plasma.

30. A method according to claim 1, further comprising:
planarizing the surface of the part with the plasma.

31. A method according to claim 1, further comprising:
using a plasma torch with multiple heads to increase the rate of removal.

32. A method for making a damage-free optic, comprising:
forming a damage-free optic by slumping, the optic being formed to a near-final shape;
measuring the topography of a surface of the optic; and
using reactive atom processing to modify the surface of the optic to a final shape.

33. A method for forming a damage-free workpiece, comprising:
supplying reactive species to a plasma torch;
bringing the plasma torch into proximity with the surface of the damage-free workpiece; and
using reactive atom plasma processing to shape the damage-free workpiece to a final form without imparting damage unto the workpiece.

34. A tool for forming a damage-free workpiece, the tool being able to accomplish the following steps:
supply reactive species to a plasma torch;
bring the plasma torch into proximity with the surface of the damage-free workpiece; and
use reactive atom plasma processing to shape the damage-free workpiece to a final form without imparting damage unto the workpiece.

35. A tool for shaping the surface of a damage-free part, comprising:
means for supplying reactive species to a plasma torch;
means for bringing the plasma torch into proximity with the surface of the damage-free part; and
means for using reactive atom plasma processing to shape the damage-free part to a final form without imparting damage unto the part.

36. A tool for shaping the surface of a damage-free part, comprising:
a flame torch; and
a translator that can translate at least one of a part and said torch;
wherein said torch is configured to receive a reactive precursor capable of chemically combining with the surface material of the part to produce a gas and leave the surface without imparting damage unto the part.

37. A tool according to claim 36, wherein:
said flame torch is adapted to generate a hydrogen-oxygen flame.

38. A tool according to claim 36, wherein:
said flame torch is adapted to produce a stream of atomic radicals that can be used to modify the surface.

39. A tool for shaping the surface of a damage-free optic, comprising:
a flame torch adapted to receive a reactive precursor;
wherein said flame torch is capable of fragmenting the reactive precursor into a stream of atomic radicals that can be used to shape the surface.
